(19) United States
(12) Patent Application Publication
(10) Pub. No.: US 2026/0361992 A1
(43) Pub. Date: Nov. 12, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: TOMOHIRO OTA, Tokyo (JP)

(21) Appl. No.: 19/648,190

(22) Filed: Apr. 15, 2026

(30) Foreign Application Priority Data
May 8, 2025 (JP) 2025-078206

(51) Int. Cl. H04N 23/611; H04N 7/18; H04N 23/63; H04N 23/661; H04N 23/67; H04N 23/69; H04N 23/695

(52) U.S. Cl. CPC H04N 23/611; H04N 23/635; H04N 23/661; H04N 23/69; H04N 23/695; H04N 7/183; H04N 23/672

(57) ABSTRACT

A control apparatus acquires position information on a wireless device, specifies an object including the wireless device within an image using the position information, and controls a display of a display unit to display a position of a first object specified as including the wireless device in a first method, and to display a position of a second object not specified as including the wireless device in a second method different from the first method.

### BACKGROUND

### Field of the Technology

The present disclosure relates to a control apparatus, an image pickup apparatus, a control method, and a storage medium.

### Description of the Related Art

Conventionally, a method has been known that performs wireless communication using a wireless device included in an object to measure an object distance and a positional relationship between the object and an image pickup apparatus, and performs imaging control using the measured result. Japanese Patent Application Laid-Open No. 2006-113316 discloses a configuration that measures a distance to an IC tag attached to an imaging target and performs autofocus (AF) control.

### SUMMARY

A control apparatus according to one aspect of the present disclosure includes one or more memories storing instructions, and one or more processors that, upon execution of the instructions, operate to acquire position information on a wireless device, specify an object including the wireless device within an image using the position information, and control a display of a display unit to display a position of a first object specified as including the wireless device in a first method, and to display a position of a second object not specified as including the wireless device in a second method different from the first method. An image pickup apparatus having the above control method also constitutes another aspect of the present disclosure. A control method corresponding to the above control apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a diagram illustrating a configuration example of a network system.

FIG. 2 is a diagram illustrating the configuration examples of a remote camera and a client apparatus.

FIG. 3 is an explanatory diagram illustrating a method for measuring an arrival direction of a radio wave.

FIG. 4 is an explanatory diagram illustrating a method for measuring a distance.

FIG. 5 is a diagram illustrating an example of an imaging screen and a detection frame display.

FIG. 6 is a diagram illustrating another example of an imaging screen and a detection frame display.

FIG. 7 is a flowchart illustrating a flow of AF control.

FIGS. 8A to 8E illustrate a flowchart of processing executed by the remote camera.

FIG. 9 is a diagram illustrating a menu display example.

FIG. 10 is a diagram illustrating an example of a display mode of a detection frame.

FIG. 11 is a diagram illustrating a display example of the detection frame.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

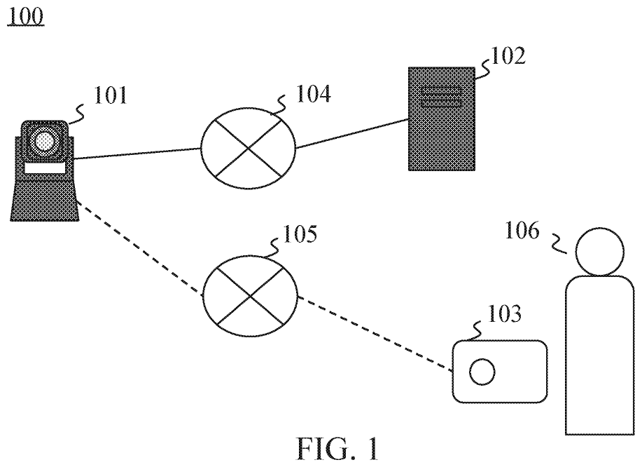

FIG. 1 is a diagram illustrating a configuration example of a network system 100 according to an embodiment of the present disclosure. The network system 100 includes a remote camera 101, a client apparatus 102, a wireless device 103, a network 104, and a wireless network 105.

The remote camera 101 is capable of video distribution and camera control (imaging or shooting control) via a wired or wireless network. The remote camera 101 functions as an image pickup apparatus.

The client apparatus 102 is connected to the remote camera 101 via the network 104. The client apparatus 102 controls the remote camera 101 and outputs information via a browser. An operation screen displayed on the browser is configured based on information output from the remote camera 101. Control events based on operations on the browser are received by the client apparatus 102 and propagated to the remote camera 101, as necessary. Therefore, a display unit and an operation unit included in the client apparatus 102 may be regarded as one example that implements a display unit and an operation unit included in the remote camera 101. The remote camera 101 and the client apparatus 102 may be replaced with a handheld video camera that incorporates the functions of both.

The wireless device 103 is connected to the remote camera 101 via the wireless network 105. The wireless device 103 incorporates a wireless communication module compliant with the IEEE 802.15.4 standard of Ultra Wide Band (registered trademark). The wireless device 103 is possessed by an object 106 imaged by the remote camera 101. In a case where the object 106 is a person, the object 106 carries the wireless device 103. As described in detail below, the wireless device 103 is used for acquiring position information on the object 106 by the remote camera 101. Although the object 106 is a person in the present embodiment, the object 106 may be an animal or a vehicle.

The network 104 is a network for distributing video captured by the remote camera 101 to an external recording server or the like, and enables mutual communication between the remote camera 101 and the client apparatus 102. In the present embodiment, the network 104 is a wired LAN, but it may be a wireless LAN.

The wireless network 105 enables mutual communication between the remote camera 101 and the wireless device 103. In the present embodiment, the wireless network 105 conforms to Ultra Wide Band (registered trademark), but may conform to other wireless communication standards such as Z-Wave (registered trademark), ZigBee (registered trademark), or Bluetooth (registered trademark).

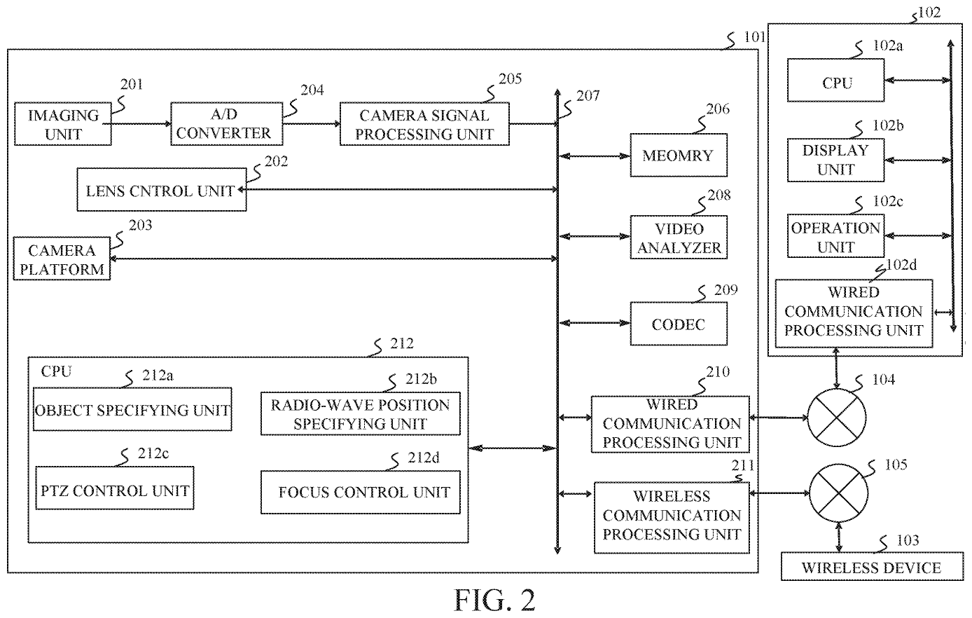

FIG. 2 is a diagram illustrating configuration examples of the remote camera 101 and the client apparatus 102. The remote camera 101 includes an imaging unit (image pickup unit) 201, a lens control unit 202, and a camera platform (universal head) 203. The remote camera 101 further includes an A/D converter 204, a camera signal processing unit 205, a memory 206, a bus 207, a video analyzer (object detector) 208, a compression/decompression unit (CODEC) 209, a wired communication processing unit 210, a wireless communication processing unit (communication unit) 211, and a CPU 212. The CPU 212 is a central processing apparatus and functions as a control apparatus. The CPU 212 serves as one or more processors that, upon execution of instructions stored in the memory 206, operate to serve as the following object specifying unit 212a, radio-wave position specifying unit, PTZ control unit 212c, and focus control unit 212d, which will be described later.

The CPU 212 may be configured to include, as a control unit, a function of the lens control unit 202 that controls the imaging unit 201.

The imaging unit 201 includes a zoom lens, a focus lens, an aperture stop (diaphragm), and an image sensor. The lens control unit 202 controls movements of the zoom lens and the focus lens along an optical axis and controls operation of the aperture stop. In the present embodiment, the lens control unit 202 controls the imaging unit 201 in accordance with position information on the wireless device 103 received from a radio-wave position specifying unit 212b described later. The lens control unit 202 may control the imaging unit 201 using information on an object (object detection information) in an image received from the video analyzer 208 described later, in addition to the position information on the wireless device 103.

In the imaging unit 201, the image sensor photoelectrically converts light passing through the zoom lens, the focus lens, and the aperture stop to generate an analog image signal. The imaging unit 201 performs amplification processing by sampling on the analog image signal generated by the image sensor and outputs the processed signal to the A/D converter 204.

The lens control unit 202 may control the imaging unit 201 using, in addition to the position information on the wireless device 103, an image-plane phase-difference signal from the imaging unit 201. The image sensor may have a configuration in which, in order to enable on-sensor phase-difference AF, pixel portions each including two photodiodes as light receivers serving as photoelectric converters for a single microlens are arranged in an array. Thereby, each pixel portion can receive light beams obtained by dividing an exit pupil of a lens. The camera signal processing unit 205 performs correlation calculation on two image signals and can calculate information such as a defocus amount and various reliabilities.

The lens control unit 202 may also control the imaging unit 201 using image information from the imaging unit 201 in addition to the position information on the wireless device 103.

The camera platform 203 includes a pan drive unit (panning unit) and a tilt drive unit (tilting unit). The CPU 212 controls the camera platform 203 via an actuator (not illustrated) to perform pan driving and tilt driving (referred to as PT driving hereinafter) for rotating the imaging unit 201 in horizontal and vertical directions, thereby changing an imaging direction.

The A/D converter 204 converts the analog image signal into a digital image signal and outputs the digital image signal to the camera signal processing unit 205. The camera signal processing unit 205 performs various types of image processing on the digital image signal to generate a video signal. Examples of the image processing include offset processing, gamma correction processing, gain processing, RGB interpolation processing, noise reduction processing, and color tone correction processing.

The memory 206 includes a RAM, a ROM, and a storage apparatus. The RAM is a volatile memory such as SRAM or DRAM. The ROM is a nonvolatile memory such as EEPROM or flash memory. The storage apparatus is a hard disk drive (HDD) or a solid state drive (SSD). Programs for realizing the functions described in the present embodiment and data used when the programs are executed are stored in the ROM or the storage apparatus. These programs and data are loaded into the RAM via the bus 207 under the control of the CPU 212 and executed by the CPU 212, thereby causing respective units to function. Thus, the memory 206 serves as one or more memories storing the instructions.

The video analyzer 208 analyzes the video signal and performs various detection processing such as human body detection, face detection, and moving object detection. As an example of video analysis for specifying a position of the object 106, human body detection in an image frame may be used; however, depending on a use case, face detection or moving object detection may be used. The video analyzer 208 outputs a video analysis result (object information) to the CPU 212 via the bus 207. The CODEC 209 performs compression processing on the video signal to generate compressed data.

The wired communication processing unit 210 performs network communication processing with the client apparatus 102 via the network 104. The wireless communication processing unit 211 is capable of communicating with the wireless device 103 and, in the present embodiment, performs wireless communication processing with the wireless device 103 via the wireless network 105. The present embodiment assumes that the wireless communication processing unit 211 is included in a wireless communication module compliant with the IEEE 802.15.4 standard of Ultra Wide Band (registered trademark); however, the present disclosure is not limited to this example. For example, the wireless communication processing unit 211 may be configured such that an external wireless communication module is connected via a general-purpose interface such as USB.

The CPU 212 controls the overall operation of the remote camera 101. The CPU 212 also indirectly controls the client apparatus 102 by transmitting control information desired by the client apparatus 102 via the network 104. Further, the CPU 212 functions as an object specifying unit (specifying unit) 212a, a radio-wave position specifying unit (acquiring unit) 212b, a PTZ control unit 212c, and a focus control unit 212d.

The object specifying unit 212a specifies, within an image, the object 106 that includes the wireless device 103, based on a detection result from the video analyzer 208 and a relative position of the object 106 specified by the radio-wave position specifying unit 212b. In a case where a plurality of persons are present, it is not possible to distinguish, based only on a human-body detection result from the video analyzer 208, between a person including the wireless device 103 and a person not including the wireless device 103. However, such distinction becomes possible by additionally considering the relative position of the object 106 specified by the radio-wave position specifying unit 212b.

The radio-wave position specifying unit 212b specifies a relative position of the wireless device 103 when viewed from the remote camera 101, that is, a relative position of the object 106 including the wireless device 103, based on a direction of arrival of a radio wave (referred to as a radio-wave direction hereinafter) received from the wireless device 103 and a distance to the wireless device 103. The method for specifying the relative position of the object 106 in the radio-wave position specifying unit 212b is based on a positioning function of wireless communication compliant with the IEEE 802.15.4 standard of Ultra Wide Band (registered trademark).

The PTZ control unit 212c controls pan driving, tilt driving, and zoom driving (PTZ driving hereinafter) based on the relative position of the object 106 acquired from the radio-wave position specifying unit 212b. In that case, the PTZ control unit 212c controls PTZ driving using the lens control unit 202 and the camera platform 203.

The focus control unit 212d controls AF for automatically focusing on an object and manual focus (MF) for moving a focus lens based on an external operation. The present embodiment has two types of AF control. The first type is AF control based on information obtained via the imaging unit 201 (imaging AF hereinafter). For example, focusing is performed by moving the focus lens to a position at which a contrast evaluation value related to contrast of a specific frequency, calculated from a video signal output from the camera signal processing unit 205, reaches a peak. The imaging AF is not limited to a contrast method and may use a phase-difference detecting method. The second type is AF control based on a distance between the remote camera 101 and the object 106 obtained from the radio-wave position specifying unit 212b (wireless communication ranging AF hereinafter). In the wireless communication ranging AF, focusing is performed by moving the focus lens to a position calculated based on the obtained object distance and lens design data (cam data). The MF control performs control for moving the focus lens to a designated position based on an instruction of an external command via the wired communication processing unit 210.

The client apparatus 102 includes a CPU 102a, a display unit 102b, an operation unit 102c, and a wired communication processing unit 102d. These components of the client apparatus 102 operate in cooperation via a bus 102e. As described above, the components of the client apparatus 102 may be incorporated in the remote camera 101.

The CPU 102a controls respective units of the client apparatus 102 based on information received from the remote camera 101 via the network 104. The CPU 102a may be implemented by the same element as the CPU 212.

The display unit 102b includes a display device capable of displaying a browser, such as an LCD or an organic EL display. In a case where the remote camera 101 and the client apparatus 102 are integrated into a handheld video camera, the browser may not necessarily be implemented as an application displayed in a window form, as long as video generated by the camera signal processing unit 205 and various information displays can be realized.

The operation unit 102c is an operation device for operating a browser displayed on the display unit 102b, and includes a mouse, a keyboard, or a controller device specialized for camera operation. In a case where the remote camera 101 and the client apparatus 102 are integrated into a handheld video camera, buttons, dials, or levers provided on a camera housing correspond to the operation unit 102c. The operation unit 102c may be a touch panel integrated with the display unit 102b, in which buttons displayed on the display unit 102b are operated by contact with the touch panel. Arbitrary camera functions may be assigned to buttons included in the display unit 102b by an assign button setting function described later. Operating a button or dial to which MF operation is assigned can control the focus lens in accordance with an intention of a photographer.

The wired communication processing unit 102d performs a role equivalent to that of the wired communication processing unit 210 of the remote camera 101. In a case where the remote camera 101 and the client apparatus 102 are integrated into a handheld video camera, the wired communication processing unit 210, the network 104, and the wired communication processing unit 102d may be replaced by internally connecting the buses 207 and 102e within the camera.

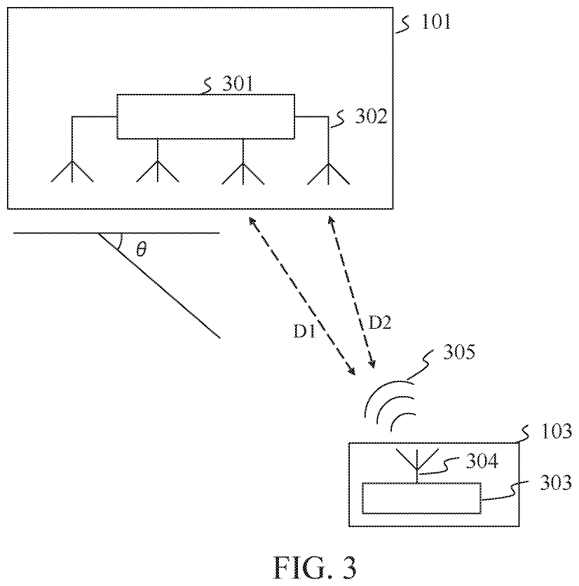

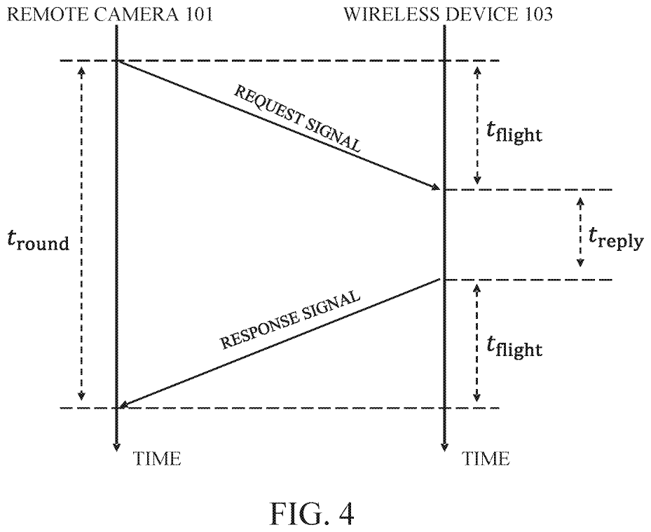

A description will now be given of a principle by which the remote camera 101 (radio-wave position specifying unit 212b) performs positioning of the wireless device 103. A position is measured by measuring a radio-wave direction and a distance. FIG. 3 is an explanatory diagram illustrating a method for measuring a radio-wave direction. FIG. 4 is an explanatory diagram illustrating a distance measuring method.

A method for measuring the radio-wave direction is referred to as Angle Of Arrival (AoA), in which a reception angle of a radio wave is calculated on the receiving device side. The remote camera 101 uses an antenna array including a plurality of antennas 302 to detect the radio-wave direction by utilizing a phase difference between radio waves resulting from differences in positions of the plurality of antennas 302.

A distance measuring method may be referred to as Time of Flight (ToF). In the ToF, a time required for signal transmission and reception is measured, and a distance between devices is calculated by multiplying the measured time by a propagation speed of radio waves (light speed).

Referring to FIG. 3, a method for measuring the radio-wave direction using AoA will be described. The remote camera 101 includes a transceiver 301 and a plurality of antennas 302 arranged at equal intervals. The wireless device 103 includes a transceiver 303 and a single antenna 304. The wireless device 103 transmits a radio wave 305 from the antenna 304 using the transceiver 303, and the remote camera 101 receives the radio wave 305 by the plurality of antennas 302. The distances between the antenna 304 and the respective antennas 302 differ, such as distances D1 and D2. Thereby, signals having different phases can be detected at the plurality of antennas 302. The remote camera 101 acquires phase information on the radio wave while switching active antennas, and calculates an incident angle θ, which is a relative direction of the signal, based on the acquired phase information. The incident angle θ is calculated using a wavelength of the radio wave, a distance between antennas, and a phase difference. The remote camera 101 can recognize a current orientation (imaging direction) of the remote camera 101 in a three-dimensional space by calibration performed at installation.

Referring to FIG. 4, a method for measuring the distance using ToF will be described. In the IEEE 802.15.4 standard, there are two schemes: Single-Sided Two-Way Ranging (SS-TWR) and Double-Sided Two-Way Ranging (DS-TWR). In the present embodiment, distance measurement using the SS-TWR method will be described as an example; however, the DS-TWR method may be used. The remote camera 101 transmits a distance-measuring request signal to the wireless device 103 using the transceiver 301. The wireless device 103, upon receiving the request signal, transmits a distance-measuring response signal. A message of the response signal includes time t_{reply} required in the wireless device 103 from reception of the request signal to transmission of the response signal. The remote camera 101, upon receiving the response signal, calculates t_{round}, which is a difference between a transmission time of the request signal and a reception time of the response signal. The remote camera 101 calculates a signal propagation time t_{flight} using the following equation (1) using the difference t_{round} and time t_{reply}:

t_{flight}=(t_{round}−t_{reply})/2 (1)

The remote camera 101 calculates a distance d between the remote camera 101 and the wireless device 103 using the propagation time t_{flight} of the signal and the light speed c as the propagation speed of the radio wave, according to Equation (2):

d=t_{flight}×c (2)

Thus, the remote camera 101 can specify the relative position of the object 106 when viewed from the remote camera 101 based on the radio-wave direction from the wireless device 103 and the distance to the wireless device 103.

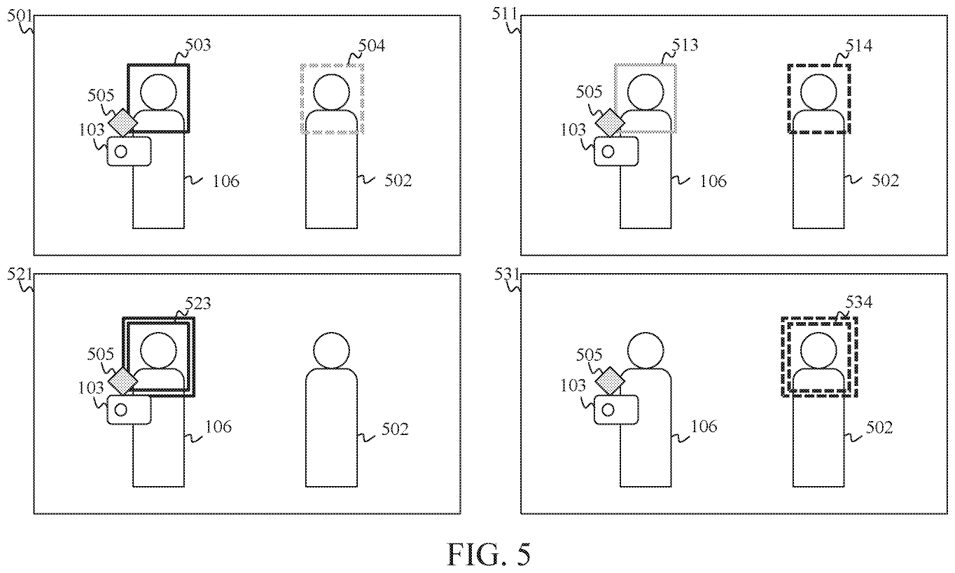

A description will now be given of an example of a method by which the object specifying unit 212a specifies, within an image frame, the object 106 including the wireless device 103. FIG. 5 illustrates an example of an imaging screen and a detection frame display, and illustrates a captured image displayed on the display unit 102b of the client apparatus 102 when the remote camera 101 captures a plurality of persons. In an image frame 501, the object 106 including the wireless device 103 and an object 502 not including a wireless device are present. As detection results from the video analyzer 208, a detection frame 503 for the object 106 and a detection frame 504 for the object 502 are output. A relative position 505 specified by the radio-wave position specifying unit 212b is located near the wireless device 103. Therefore, a detection frame closest to the relative position 505 (in this case, the detection frame 503) is specified as corresponding to the object including the wireless device 103.

At this time, the detection frame 503 corresponding to the object specified as including the wireless device 103 (a first object) is displayed as a solid-line rectangle. The detection frame 504 corresponding to the object specified as not including the wireless device 103 (a second object) is displayed as a dashed-line rectangle. By differentiating display modes of the detection frames in this manner, a photographer operating the client apparatus 102 can easily determine which object includes the wireless device 103. In a case where the object 106 forgets to carry the wireless device 103 or the wireless device 103 is not functioning, this can be easily noticed at a start of imaging (shooting) because a frame is displayed as a dashed-line rectangle like the detection frame 504.

In the image frame 501, which object is a main object serving as an AF target may be visualized. The present embodiment makes different a method for displaying the main object (a third method) from a method for displaying an object specified as including the wireless device 103 (a first method) and a method for displaying an object specified as not including the wireless device 103 (a second method). More specifically, a frame for the main object is displayed in a dark color like the detection frame 503, whereas a frame for an object that is not the main object is displayed in a light color like the detection frame 504. Thus, information on whether the wireless device 103 is included, expressed by distinction between the solid and dashed lines, can be presented in combination with distinction of the main object. In a case where the main object is changed by the operation unit 102c, the display content of the display unit 102b is changed as in an image frame 511. That is, a detection frame 514 for the object 502 that becomes the main object is displayed in a dark color, and a detection frame 513 for the object 106 that is no longer the main object is displayed in a light color.

It is also desirable to visualize which object is being tracked (information on a tracking operation). The present embodiment makes different a method for displaying a tracked object (a fourth method) from a method for displaying an object specified as including the wireless device 103 (a first method) and a method for displaying an object specified as not including the wireless device 103 (a second method). Image frames 521 and 531 illustrate display examples on the display unit 102b in an object tracking mode. In a case where the object 106 including the wireless device 103 is being tracked, a detection frame 523 for the object 106 is configured by a dark double line indicating tracking and a solid line indicating that the wireless device 103 is included. On the other hand, in a case where the object 502 not including the wireless device 103 is being tracked, a detection frame 534 for the object 502 is configured by a dark double line indicating tracking and a dashed line indicating that the wireless device 103 is not included. In this manner, information on a tracking state and information on whether the wireless device 103 is possessed can both be expressed in the detection frame display.

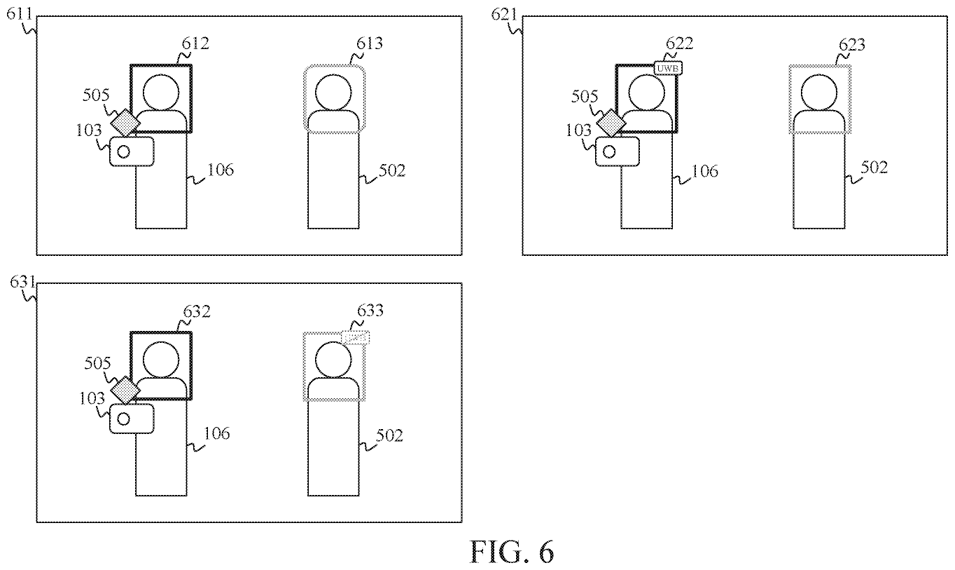

The possession or non-possession of the wireless device 103 may be expressed in a manner different from the display example of FIG. 5. FIG. 6 is a diagram illustrating another example of an imaging screen and a detection frame display. The present disclosure can be implemented with either of the display modes of FIGS. 5 and 6, and is not limited to these display modes.

In an image frame 611, a detection frame 612 for the object 106 possessing the wireless device 103 is displayed as a solid-line rectangular frame with sharp corners, and a detection frame 613 for the object 502 not including the wireless device 103 is displayed as a solid-line rectangular frame with rounded corners.

In an image frame 621, the detection frame 612 for the object 106 possessing the wireless device 103 is displayed as a rectangular frame with a “UWB” icon, and the detection frame 613 for the object 502 not including the wireless device 103 is displayed as a rectangular frame without the “UWB” icon.

In an image frame 631, the detection frame 612 for the object 106 possessing the wireless device 103 is displayed as a rectangular frame without the “UWB” icon, and the detection frame 613 for the object 502 not including the wireless device 103 is displayed as a rectangular frame with an icon in which “UWB” is crossed out with a diagonal line.

In any of the display examples, whether an object is a main object can be indicated by darkness/lightness of a frame line in combination with information on the possession or non-possession of the wireless device 103.

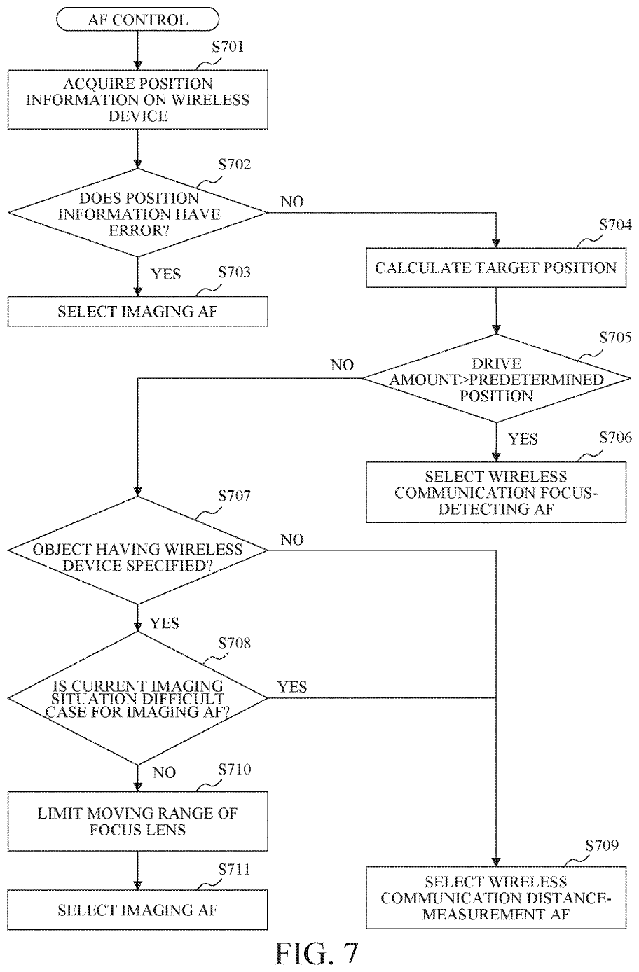

A description will now be given of the processing executed by the remote camera 101. First, AF control will be described with reference to FIG. 7. FIG. 7 is a flowchart illustrating a flow of AF control. The processing of FIG. 7 is achieved by the CPU 212 controlling the respective units in the remote camera 101. Alternatively, the remote camera 101 performs the AF control while automatically selecting between imaging AF and wireless ranging AF.

In step S701, the CPU 212 acquires, from the radio-wave position specifying unit 212b, a relative position of the object 106 when viewed from the remote camera 101 (position information on the wireless device 103). Thereby, an object distance is also acquired.

In step S702, the CPU 212 determines whether the relative position acquired in step S701 includes an error. For example, the CPU 212 determines that the relative position includes an error in a case where the position information cannot be acquired due to failure of radio wave reception or in a case where reliability is low such that the object distance is extremely unstable. This determination method is merely an example, and other methods may be used. In a case where the CPU 212 determines that the relative position has an error, the CPU 212 executes processing of step S703, and in a case where the CPU 212 determines otherwise, the CPU 212 executes processing of step S704.

In step S703, the CPU 212 selects imaging AF.

In step S704, the CPU 212 calculates a target position of the focus lens based on the object distance obtained in step S701.

In step S705, the CPU 212 determines whether a drive amount to the target position of the focus lens calculated in step S704 is greater than a predetermined amount. The drive amount to the target position of the focus lens may be regarded as a defocus amount of the object 106, but if the defocus amount is large, imaging AF may incorrectly determine a focusing direction. In contrast, in the wireless ranging AF, the target position of the focus lens is known, and therefore focusing can be performed quickly. In a case where the CPU 212 determines that the drive amount to the target position of the focus lens is greater than the predetermined amount, the CPU 212 executes processing of step S706, and in a case where the CPU 212 determines otherwise, the CPU 212 executes processing of step S707. In a case where the drive amount is equal to the predetermined amount, which step is executed may be set arbitrarily.

In step S706, the CPU 212 selects the wireless ranging AF.

In step S707, the CPU 212 determines whether the object 106 including the wireless device 103 has been specified within the image frame by the object specifying unit 212a. In a case where the CPU 212 determines that the object 106 including the wireless device 103 has been specified, the CPU 212 executes processing of step S708, and in a case where the CPU 212 determines otherwise, the CPU 212 executes processing of step S709.

In step S708, the CPU 212 determines whether a current imaging condition is a difficult case for the imaging AF. Difficult cases vary according to AF methods; for example, in a contrast method, difficult cases may include low illuminance, night scenes or point light sources, high noise, a slow shutter, and a low frame rate. In a case where the CPU 212 determines that the current imaging condition is a difficult case for the imaging AF, the CPU 212 executes processing of step S709, and in a case where the CPU 212 determines otherwise, the CPU 212 executes processing of step S710.

In step S709, when the CPU 212 determines in step S707 that the object 106 including the wireless device 103 has not been specified, the imaging AF may involve a risk of focusing on an area different from an intended object, and thus the CPU 212 selects wireless ranging AF. In addition, when the CPU 212 determines in step S708 that the current imaging condition is a difficult case for the imaging AF, the imaging AF may involve a risk of failing to focus normally, and thus the CPU 212 selects wireless ranging AF.

In step S710, the CPU 212 limits a moving range of the focus lens.

In step S711, in order to perform AF control such that a best focus is achieved as an actual image, the CPU 212 selects imaging AF, which can achieve higher focusing accuracy than wireless ranging AF. In step S710, the moving range of the focus lens is limited such that only an area near the target position of the focus lens calculated in step S704 becomes the moving range. This can suppress a large focusing error in an unexpected situation and to achieve imaging AF with improved stability.

After the imaging AF is selected in step S703 or step S711, AF may be continuously executed while tracking a target object using the conventional method. In the present embodiment, the CPU 212 as a control unit performs tracking control on a tracking target. After wireless ranging AF is selected in step S706 or step S709, continuing execution of wireless ranging AF provides an effect of tracking AF for the wireless device 103. In the following description of the flow, the tracking AF based on the conventional method and the tracking AF based on wireless communication distance-measurement will be collectively referred to as tracking AF.

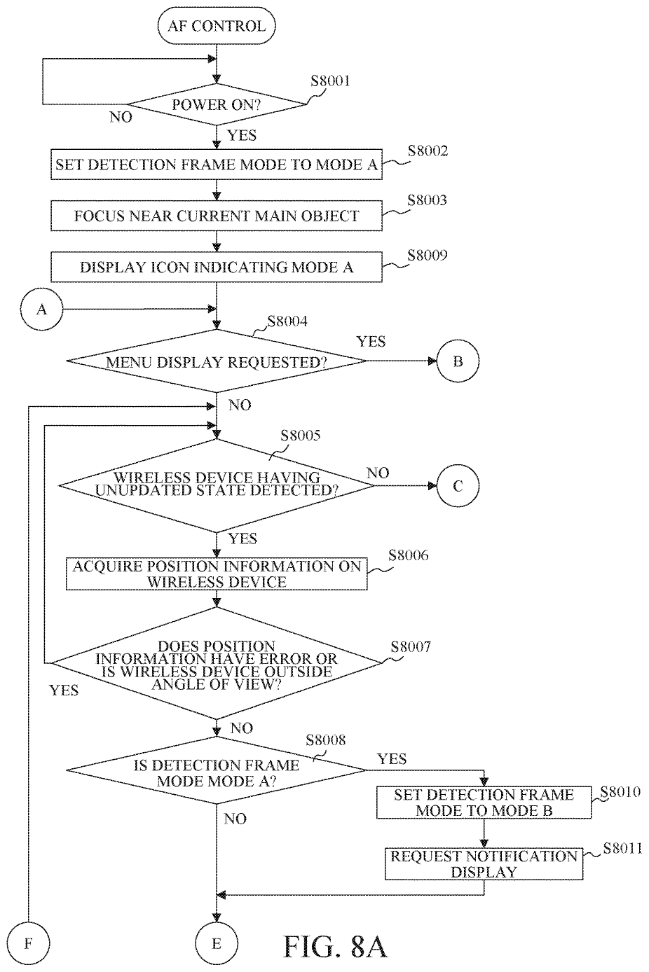

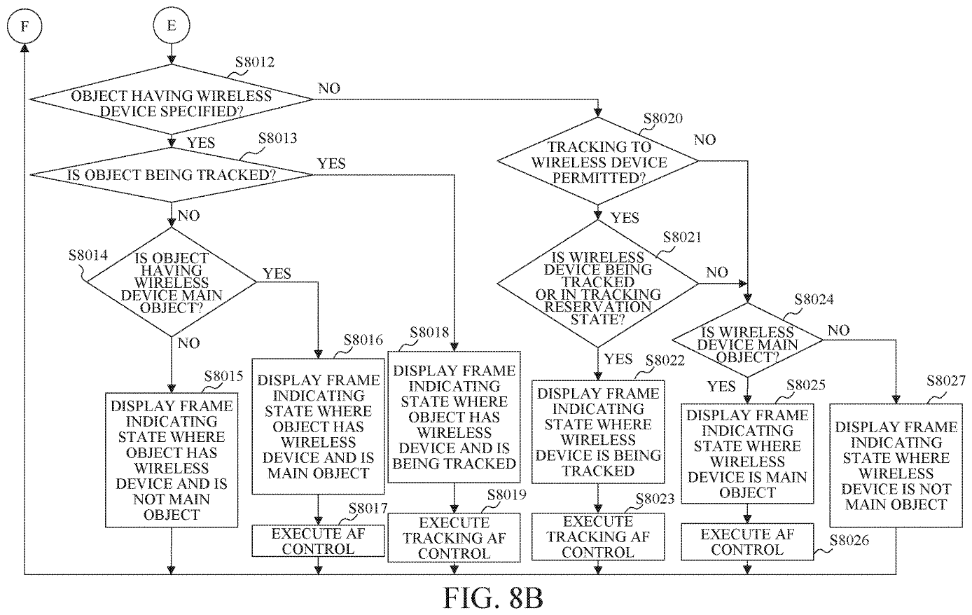

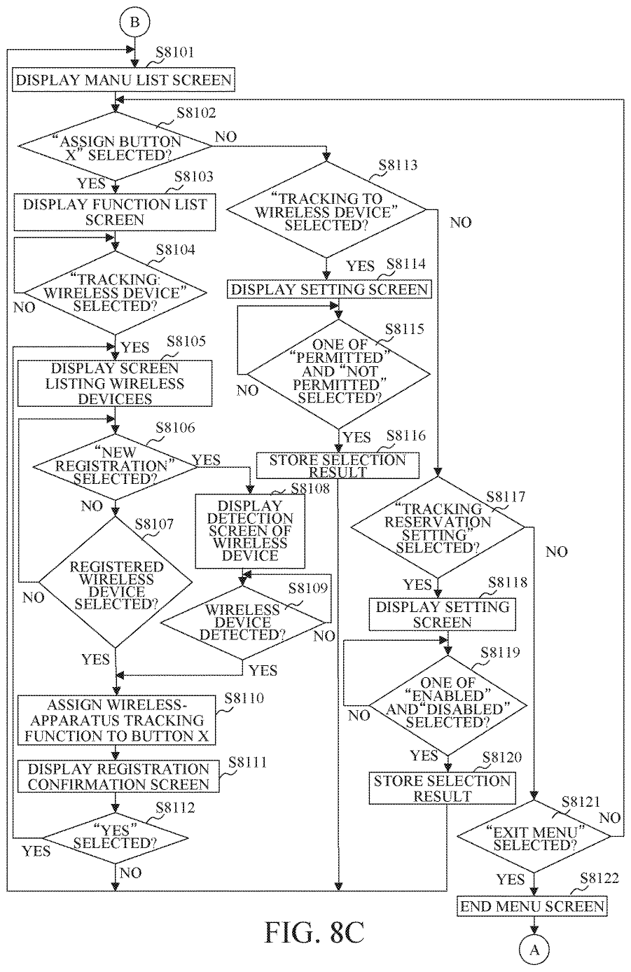

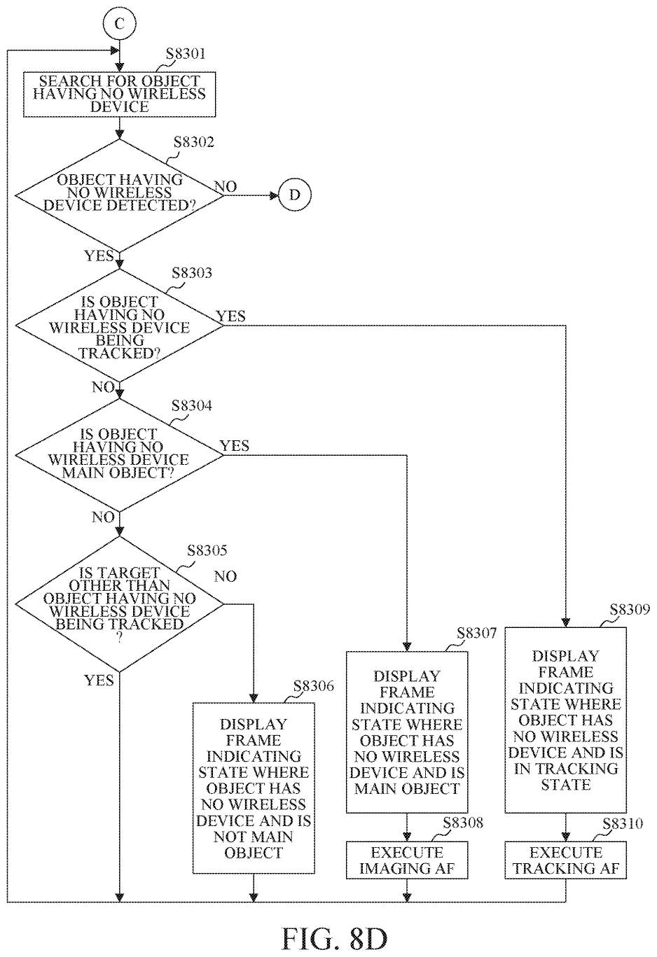

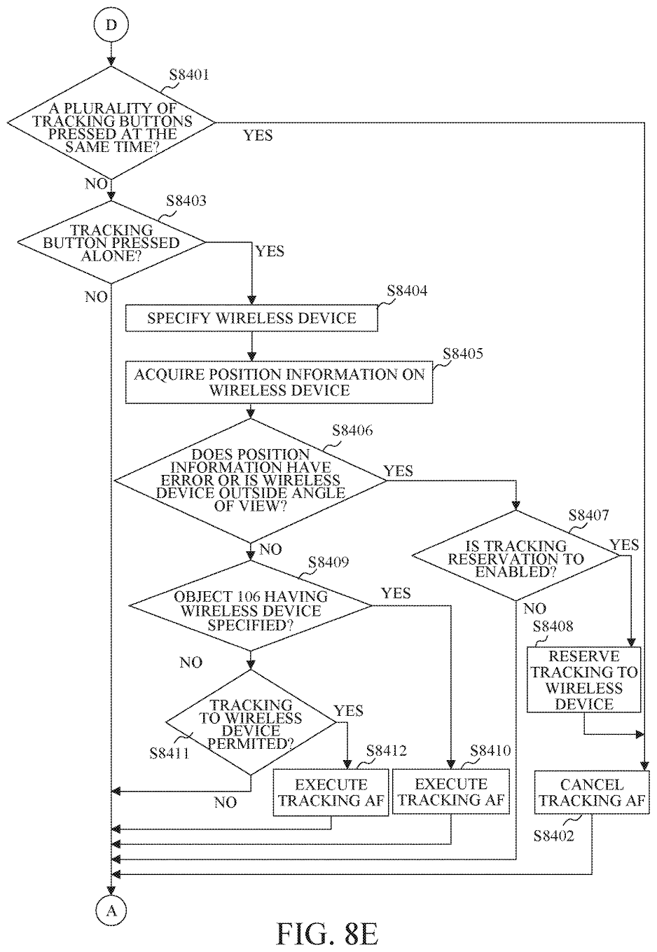

Next, the overall control of the remote camera 101 related to AF operation will be described with reference to FIGS. 8A to 8E. FIGS. 8A, 8B, 8C, and 8D are flowcharts illustrating processing executed by the remote camera 101. The processing of FIGS. 8A to 8E is realized by the CPU 212 controlling respective units of the remote camera 101.

In step S8001, the CPU 212 determines whether the remote camera 101 has been powered on. In a case where the CPU 212 determines that the remote camera 101 has been powered on, the CPU 212 executes processing of step S8002, and when the CPU 212 determines otherwise, the CPU 212 repeats the processing of this step.

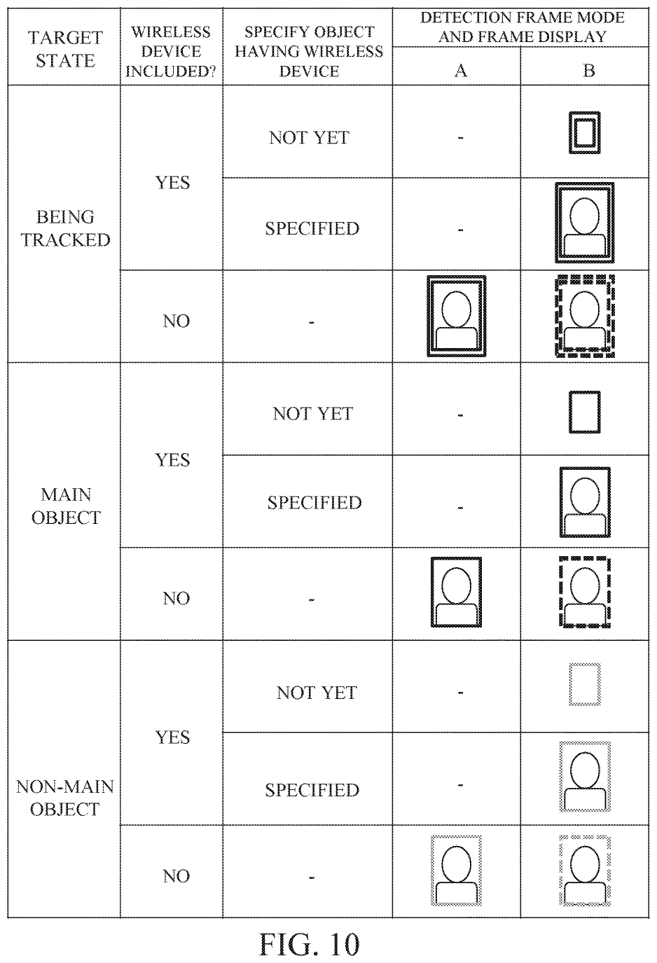

In step S8002, the CPU 212 sets a mode of a detection frame to be displayed on the display unit 102b (detection frame mode) to Mode A. Mode A is a display mode in a case where the wireless device 103 is not used. FIG. 10 illustrates an example of the display modes of the detection frame in Modes A and B. In Mode A, even in a case where an object not including the wireless device 103 is in any of the states of being tracked, being a main object, or being a non-main object, the object is displayed in a frame mode similar to that of a specified object including the wireless device 103 in Mode B described later. This can display a frame of a main object in the most visible mode even in an imaging situation where the wireless device 103 is not used.

In step S8003, the CPU 212 focuses near the current main object. This step performs focusing near the main object by the AF control of FIG. 7, or focusing on an object not including the wireless device 103 by AF control different from the AF control of FIG. 7. Alternatively, without using AF, a photographer may perform focusing by MF operation, or the photographer or the object may move to a distance near an in-focus distance.

In step S8009, the CPU 212 causes the display unit 102b to display an icon indicating that Mode A is set, that is, that a detection frame mode in which the wireless device 103 is not used is not used.

In step S8004, the CPU 212 determines whether a menu display has been requested based on an operation on the operation unit 102c. In a case where the CPU 212 determines that the menu display has been requested, the CPU 212 executes the flow of FIG. 8C, and in a case where the CPU 212 determines otherwise, the CPU 212 executes processing of step S8005.

In step S8005, the CPU 212 determines whether the wireless communication processing unit 211 has detected the wireless device 103 whose state is not updated. In a case where the CPU 212 determines that the wireless device 103 whose state is not updated has been detected, the CPU 212 executes processing of step S8006, and in a case where the CPU 212 determines otherwise, the CPU 212 executes the flow of FIG. 8D.

In step S8006, the CPU 212 acquires the relative position of the object 106 by control similar to that of step S701.

In step S8007, the CPU 212 performs error determination by control similar to that of step S702 and determines whether the wireless device 103 (object 106) is within the angle of view. In a case where the CPU 212 determines that the relative position includes an error or determines that the wireless device 103 is outside the angle of view, the CPU 212 executes processing of step S8005, and in a case where the CPU 212 determines otherwise, the CPU 212 executes processing of step S8008.

In step S8008, the CPU 212 determines whether a current detection frame mode is Mode A. In a case where the CPU 212 determines that the current detection frame mode is Mode A, the CPU 212 executes processing of step S8010.

In step S8010, the CPU 212 sets the detection frame mode to Mode B. In Mode B, as illustrated in FIGS. 5 and 6, the detection frame is displayed in different display modes according to whether an object includes the wireless device 103 and whether an object including the wireless device 103 can be specified. This can display, in a more easily viewable mode, an object including the wireless device 103 that is highly likely to be a main object, and also display, in an easily viewable manner, a target even when AF is performed for the wireless device 103 in a case where an object cannot be specified.

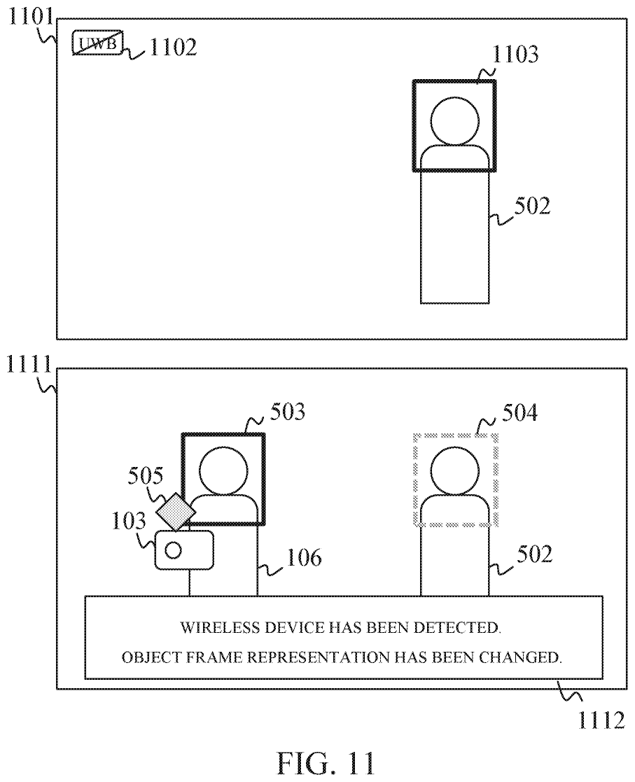

In step S8011, the CPU 212 requests the client apparatus 102 to display a notification. FIG. 11 is a diagram illustrating an example of a detection frame display. A screen 1101 illustrates the display content in step S8009. An icon 1102 is an icon indicating Mode A. A position of an object not including the wireless device 103 is displayed by a detection frame 1103 that is a solid-line rectangle. A screen 1111 illustrates the display content in step S8011. An icon 1112 indicates that the wireless device 103 has been newly detected and that a display mode of the detection frame has been changed. Even if the display mode of the detection frame is suddenly changed from Mode A to Mode B, such a notification display allows a photographer to continue imaging without confusion. A position of an object 106 including the wireless device 103 is displayed by the detection frame 503 that is a solid-line rectangle, and a position of an object 502 not including the wireless device 103 is displayed by the detection frame 504 that is a dashed-line rectangle. The detection frames 503 and 1103 have the same display mode, but the presence or absence of the icon 1102 allows the photographer to determine whether the wireless device 103 is being used.

In step S8012, similarly to step S707, it is determined whether the object 106 including the wireless device 103 has been specified. In a case where the CPU 212 determines that the object 106 including the wireless device 103 has been specified, the CPU 212 executes processing of step S8013, and in a case where the CPU 212 determines otherwise, the CPU 212 executes processing of step S8020.

In step S8013, the CPU 212 determines whether the object 106 is being tracked. In a case where the CPU 212 determines that the object 106 is being tracked, the CPU 212 executes processing of step S8018, and in a case where the CPU 212 determines otherwise, the CPU 212 executes processing of step S8014. In the present embodiment, the object specifying unit 212a functions as a determining unit for determining a tracking target using position information on the wireless device 103.

In step S8014, the CPU 212 determines whether the object 106 is a main object. In a case where the CPU 212 determines that the object 106 including the wireless device 103 is a main object, the CPU 212 executes processing of step S8016, and in a case where the CPU 212 determines otherwise, the CPU 212 executes processing of step S8015.

In step S8015, the CPU 212 requests the client apparatus 102 to display the position of the object 106 on the display unit 102b with a frame indicating, in Mode B, a state where the object includes the wireless device 103 and is not a main object. That is, in the present embodiment, the CPU 212 as a control unit controls display on the display unit 102b.

In step S8016, the CPU 212 requests the client apparatus 102 to display the position of the object 106 on the display unit 102b with a frame indicating a state where the object includes the wireless device 103 in Mode Band is a main object.

In step S8017, the CPU 212 performs the AF control of FIG. 7 on the object 106.

In step S8018, the CPU 212 requests the client apparatus 102 to display the position of the object 106 on the display unit 102b with a frame indicating a state where the object includes the wireless device 103 in Mode B and is being tracked.

In step S8019, the CPU 212 performs tracking AF control on the object 106.

In step S8020, the CPU 212 determines, based on information stored in the memory 206, whether tracking to the wireless device 103 is permitted by a flow of steps S8113 to S8116 described later. In a case where the CPU 212 determines that tracking to the wireless device 103 is permitted, the CPU 212 executes processing of step S8021, and in a case where the CPU 212 determines otherwise, the CPU 212 executes processing of step S8024.

In step S8021, the CPU 212 determines whether the wireless device 103 is being tracked or is in a tracking reservation state. In a case where the CPU 212 determines that the wireless device 103 is being tracked or is in the tracking reservation state, the CPU 212 executes processing of step S8022, and in a case where the CPU 212 determines otherwise, the CPU 212 executes processing of step S8024.

In step S8022, the CPU 212 requests the client apparatus 102 to display the position of the object 106 on the display unit 102b with a frame indicating a state where the wireless device 103 in Mode B is being tracked.

In step S8023, the CPU 212 performs tracking AF control for the wireless device 103.

In step S8024, the CPU 212 determines whether the wireless device 103 is the main object. In a case where the CPU 212 determines that the wireless device 103 is the main object, the CPU 212 executes processing of step S8025, and in a case where the CPU 212 determines otherwise, the CPU 212 executes processing of step S8027.

In step S8025, the CPU 212 requests the client apparatus 102 to display the position of the object 106 on the display unit 102b with a frame indicating a state where the wireless device 103 in Mode B is the main object.

In step S8026, the CPU 212 performs AF control for the wireless device 103, similarly to step S709.

In step S8027, the CPU 212 requests the client apparatus 102 to display the position of the object 106 on the display unit 102b with a frame indicating a state where the wireless device 103 in Mode B is not the main object.

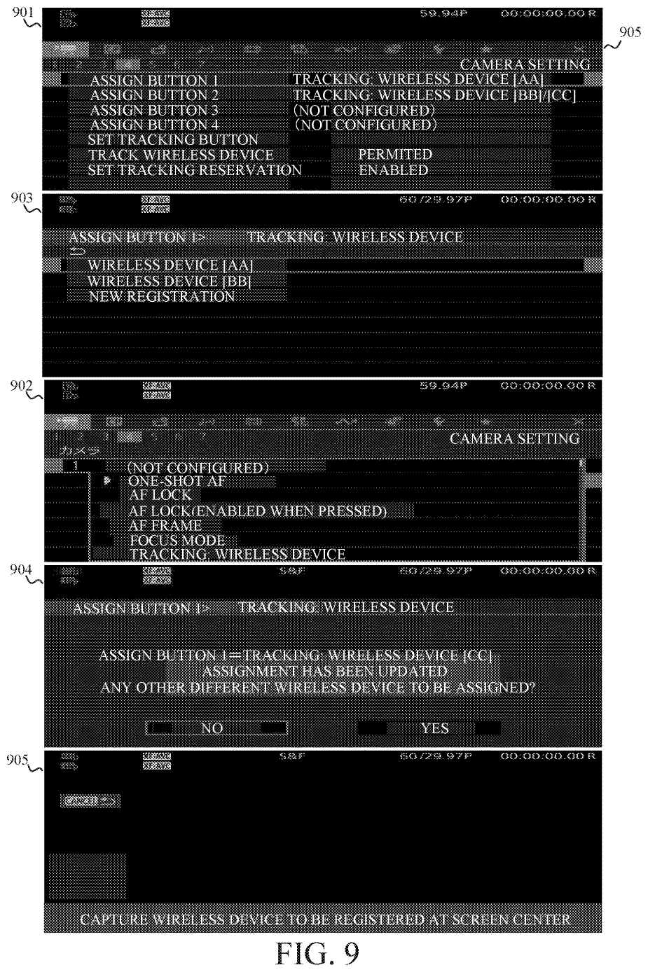

FIG. 8C illustrates a flow related to setting menu control branched from FIGS. 8A and 8B. FIG. 9 is a diagram illustrating an example of a menu display displayed on the display unit 102b.

In step S8101, the CPU 212 requests the client apparatus 102 to display a menu list screen 901. Setting items are listed on the screen, and any setting item can be selected with a cursor.

In step S8102, the CPU 212 determines whether “assign button X” has been selected. The “assign button X” is for selecting a function to be assigned to a button X included in the operation unit 102c. In a case where the CPU 212 determines that the “assign button X” has been selected, the CPU 212 executes processing of step S8103, and in a case where the CPU 212 determines otherwise, the CPU 212 executes processing of step S8113.

In step S8103, the CPU 212 requests the client apparatus 102 to display a list screen 902 of functions assignable to the button X.

In step S8104, the CPU 212 determines whether “tracking: wireless device” has been selected from the function list. In a case where the CPU 212 determines that “tracking: wireless device” has been selected, the CPU 212 executes processing of step S8105, and in a case where the CPU 212 determines otherwise, the CPU 212 repeats processing of this step.

In step S8105, the CPU 212 requests the client apparatus 102 to display a screen 903 listing wireless devicees 103 registered in the memory 206. In the screen 903, “new registration” can be selected in addition to the wireless devicees 103 already registered.

In step S8106, the CPU 212 determines whether “new registration” has been selected. When the CPU 212 determines that “new registration” has been selected, the CPU 212 executes processing of step S8108, and in a case where the CPU 212 determines otherwise, the CPU 212 executes processing of step S8107.

In step S8107, the CPU 212 determines whether a registered wireless device 103 has been selected. In a case where the CPU 212 determines that a registered wireless device 103 has been selected, the CPU 212 executes processing of step S8110, and in a case where the CPU 212 determines otherwise, the CPU 212 executes processing of step S8106.

In step S8108, the CPU 212 requests the client apparatus 102 to display a detection screen 905 of the wireless device 103. The detection screen 905 displays a message prompting imaging of the wireless device 103 to be registered near a center of video.

In step S8109, the CPU 212 determines whether the wireless device 103 has been detected near a center of an angle of view by the radio-wave position specifying unit 212b. In a case where the CPU 212 determines that the wireless device 103 has been detected, the CPU 212 executes processing of step S8110, and in a case where the CPU 212 determines otherwise, the CPU 212 repeats processing of this step.

In step S8110, the CPU 212 assigns, to the button X selected in step S8102, a function of tracking the wireless device 103 specified in step S8107 or step S8109, and stores the assignment in the memory 206. In a case where the wireless device 103 is newly detected in step S8109, the detected wireless device 103 is registered in the memory 206.

In step S8111, the CPU 212 requests the client apparatus 102 to display a registration confirmation screen 904. The registration confirmation screen 904 includes an item for selecting “Yes” or “No” as to whether another wireless device 103 is further assigned to the button X.

In step S8112, the CPU 212 determines whether “Yes” has been selected. In a case where the CPU 212 determines that “Yes” has been selected, the CPU 212 executes processing of step S8105. Thereby, the registration of the wireless device 103 is repeated, and the tracking functions for a plurality of wireless devicees can be assigned to the button X. In a case where the CPU 212 determines otherwise, the CPU 212 executes processing of step S8101.

In step S8113, the CPU 212 determines whether “tracking to wireless device” has been selected. When the CPU 212 determines that the “tracking to wireless device” has been selected, the CPU 212 executes processing of step S8114, and in a case where the CPU 212 determines otherwise, the CPU 212 executes processing of step S8117.

In step S8114, the CPU 212 requests the client apparatus 102 to display a setting screen for selecting whether the “tracking to wireless device” is “permitted” or “not permitted.”

In step S8115, the CPU 212 determines whether one of “permitted” and “not permitted” has been selected. In a case where the CPU 212 determines that one of “permitted” and “not permitted” has been selected, the CPU 212 executes processing of step S8116.

In step S8116, the CPU 212 causes the memory 206 to store a selection result of step S8115.

In step S8117, the CPU 212 determines whether “tracking reservation setting” has been selected. In a case where the CPU 212 determines that the “tracking reservation setting” has been selected, the CPU 212 executes processing of step S8118, and in a case where the CPU 212 determines otherwise, the CPU 212 executes processing of step S8121.

In step S8118, the CPU 212 requests the client apparatus 102 to display a setting screen for selecting whether the “tracking reservation setting” is set to “enabled” or “disabled.”

In step S8119, the CPU 212 determines whether one of “enabled” and “disabled” has been selected. In a case where the CPU 212 determines that one of “enabled” and “disabled” has been selected, the CPU 212 executes processing of step S8120, and in a case where the CPU 212 determines otherwise, the CPU 212 repeats processing of this step.

In step S8120, the CPU 212 causes the memory 206 to store a selection result of step S8119.

In step S8121, the CPU 212 determines whether an icon meaning “exit menu” has been selected. In a case where the CPU 212 determines that the icon meaning “exit menu” has been selected, the CPU 212 executes processing of step S8122, and in a case where the CPU 212 determines otherwise, the CPU 212 executes processing of step S8102.

In step S8122, the CPU 212 requests the client apparatus 102 to end the menu screen.

FIG. 8D illustrates a control flow for an object having no wireless device 103, which branches off from FIGS. 8A and 8B.

In step S8301, the CPU 212 searches, using the video analyzer 208, for the object 502 having no wireless device 103 that has not been detected in the flows of FIGS. 8A and 8B.

In step S8302, the CPU 212 determines whether the object 502 has been detected in step S8301. In a case where the CPU 212 determines that the object 502 has been detected, the CPU 212 executes processing of step S8303, and in a case where the CPU 212 determines otherwise, the CPU 212 executes the flow of FIG. 8E.

In step S8303, the CPU 212 determines whether the object 502 is being tracked. In a case where the CPU 212 determines that the object 502 is being tracked, the CPU 212 executes processing of step S8309, and in a case where the CPU 212 determines otherwise, the CPU 212 executes processing of step S8304.

In step S8304, the CPU 212 determines whether the object 502 is a main object. In a case where the CPU 212 determines that the object 502 is a main object, the CPU 212 executes processing of step S8307, and in a case where the CPU 212 determines otherwise, the CPU 212 executes processing of step S8305.

In step S8305, the CPU 212 determines whether a target other than the object 502 is being tracked. In a case where the CPU 212 determines that a target other than the object 502 is being tracked, the CPU 212 executes processing of step S8301 without displaying a frame for the object 502 detected in step S8301, and in a case where the CPU 212 determines otherwise, the CPU 212 executes processing of step S8306.

In step S8306, the CPU 212 requests the client apparatus 102 to display the position of the object 502 on the display unit 102b with a frame indicating, in a current detection frame mode, a state where the object does not include the wireless device 103 and is not a main object.

In step S8307, the CPU 212 requests the client apparatus 102 to display the position of the object 502 on the display unit 102b with a frame indicating, in the current detection frame mode, a state where the object does not include the wireless device 103 and is a main object.

In step S8308, the CPU 212 performs imaging AF on the object 502.

In step S8309, the CPU 212 requests the client apparatus 102 to display the position of the object 502 on the display unit 102b with a frame indicating, in the current detection frame mode, a state where the object has no wireless device 103 and is in a tracking state.

In step S8310, the CPU 212 performs tracking AF on the object 502.

FIG. 8E illustrates a state transition flow relating to tracking, which branches off from FIG. 8D.

In step S8401, the CPU 212 determines whether a plurality of buttons (tracking buttons) to which a tracking function has been assigned in the flow of FIG. 8C have been pressed simultaneously. In a case where the CPU 212 determines that the plurality of buttons have been pressed simultaneously, the CPU 212 executes processing of step S8402, and in a case where the CPU 212 determines otherwise, the CPU 212 executes processing of step S8403.

In step S8402, the CPU 212 cancels tracking AF. By canceling tracking AF based on the operation in step S8401, tracking AF can be canceled without providing a dedicated tracking cancel button, thereby allowing limited buttons to be utilized more effectively.

In step S8403, the CPU 212 determines whether a button to which the tracking function has been assigned in the flow of steps S8102 to S8112 has been pressed alone. In a case where the CPU 212 determines that the button has been pressed, the CPU 212 executes processing of step S8404, and in a case where the CPU 212 determines otherwise, the CPU 212 executes the flows of FIGS. 8A and 8B.

In step S8404, the CPU 212 specifies, from information stored in the memory 206, the wireless device 103 assigned to the button pressed in step S8403. In a case where a single wireless device 103 is assigned, that wireless device is selected. In a case where a plurality of wireless devicees 103 are assigned, a different one is selected each time the button press in step S8403 is repeated. This allows a request to track an arbitrary one of a plurality of wireless devicees 103 to be accepted with a single button, thereby allowing a limited button to be utilized effectively.

In step S8405, similarly to step S701, the CPU 212 acquires position information on the specified wireless device 103.

In step S8406, the CPU 212 performs error determination by control similar to that of step S702 and determines whether the wireless device 103 is within the angle of view. This step can avoid starting undesired tracking control in a case where position control is not as expected or in a case where an object to be subjected to AF is outside the angle of view. In a case where the CPU 212 determines that the relative position includes an error or determines that the wireless device 103 is outside the angle of view, the CPU 212 executes processing of step S8407, and in a case where the CPU 212 determines otherwise, the CPU 212 executes processing of step S8409.

In step S8407, the CPU 212 determines, from information stored in the memory 206, whether tracking reservation is set to enabled by the flow of steps S8117 to S8120. In a case where the CPU 212 determines that tracking reservation is set to enabled, the CPU 212 executes processing of step S8408, and in a case where the CPU 212 determines otherwise, the CPU 212 executes the flows of FIGS. 8A and 8B.

In step S8408, the CPU 212 reserves tracking to the wireless device 103 and stores the reservation in the memory 206.

In step S8409, similarly to step S707, the CPU 212 determines whether the object specifying unit 212a has been able to specify, within an image frame, the object 106 including the wireless device 103. In a case where the CPU 212 determines that the object 106 including the wireless device 103 has been able to be specified, the CPU 212 executes processing of step S8410, and in a case where the CPU 212 determines otherwise, the CPU 212 executes processing of step S8411.

In step S8410, the CPU 212 starts tracking AF for the object 106 specified in step S8409.

In step S8411, the CPU 212 determines, from information stored in the memory 206, whether tracking to the wireless device 103 is permitted by the flow of steps S8113 to S8116. In a case where the CPU 212 determines that tracking to the wireless device 103 is permitted, the CPU 212 executes processing of step S8412, and in a case where the CPU 212 determines otherwise, the CPU 212 executes processing of the flows of FIGS. 8A and 8B.

In step S8412, the CPU 212 starts tracking AF for the wireless device 103.

As described above, the configuration of the present embodiment enables a photographer to easily confirm, based on a display mode of a detection frame or the icon 1102, whether an object includes a wireless device and whether beneficial imaging control can be performed for that object. Therefore, in a case where the photographer forgets to carry the wireless device or the wireless device is not properly functioning due to some factor, the photographer can promptly notice this, and can capture an image with increased confidence.

An object having the wireless device can be accurately identified and selected by a single button operation without relying on individual recognition technology based on image analysis. Therefore, a photographer who performs a variety of operations on the client apparatus can easily use tracking control without being burdened by object selection. In a case where the remote camera and the client apparatus are integrated into a handheld camera, a stable orientation of an object can be selected even in situations in which camera operation is restricted, such as when a gimbal is used, and tracking control can be used accurately and with confidence in more situations. The fact that the photographer can arbitrarily set which wireless device is assigned to which button contributes not only to the above operability but also enables smooth handling in a situation where a wireless device fails and is replaced with another one.

Even in a case where an object having a wireless device cannot be specified when a request to start tracking is received, the wireless device can be temporarily tracked, and once the object can be specified, a tracking target can be switched to the object and tracking can be continued. Therefore, tracking can be started more reliably in a variety of imaging conditions, and, in a case where the condition improves, control can automatically shift to tracking control with higher accuracy.

Further, whether to perform tracking to the wireless device can be selected in advance by a menu setting. In a case where a tracking request is received in a situation where the wireless device desired to be tracked cannot be detected or is outside an angle of view, whether to reserve tracking to the wireless device can also be selected in advance by a menu setting. Providing these settings allows a photographer to arbitrarily select whether to accept a tracking request even in a case where an intended tracking request cannot be received or in a case where tracking control may not be sufficiently accurate. Thereby, the user can perform proper imaging control in accordance with an imaging situation and a photographer preference.

The present embodiment utilizes the distance-measurement technology using a wireless device for the AF control; however, the present disclosure is not limited to the AF control. For example, the present disclosure may be applied to a case where a wireless device is used to specify or track an object that serves as a reference when controlling pan, tilt, zoom, auto-exposure, or a combination thereof.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-078206, filed on May 8, 2025, which is hereby incorporated by reference herein in its entirety.

What is claimed is:

1. A control apparatus comprising:
one or more memories storing instructions; and
one or more processors that, upon execution of the instructions, operate to:
acquire position information on a wireless device,
specify an object including the wireless device within an image using the position information, and
control a display of a display unit to display a position of a first object specified as including the wireless device in a first method, and to display a position of a second object not specified as including the wireless device in a second method different from the first method.

2. The control apparatus according to claim 1, wherein the one or more processors operate to control an imaging unit in accordance with the position information in a case where the first object is a main object.

3. The control apparatus according to claim 2, wherein the one or more processors operate to control at least one of autofocus, pan, tilt, zoom, and auto-exposure of the imaging unit.

4. The control apparatus according to claim 2, wherein the one or more processors operate to control the imaging unit in accordance with the position information and at least one of information on an object within the image, an image-plane phase-difference signal from the imaging unit, and image information from the imaging unit.

5. The control apparatus according to claim 1, wherein the one or more processors operate to control the display of the display unit to display a position of a main object in a third method different from each of the first method and the second method.

6. The control apparatus according to claim 1, wherein the one or more processors operate to control the display of the display unit to display information on a tracking operation in a fourth method different from each of the first method and the second method.

7. The control apparatus according to claim 1, wherein the one or more processors operate to control the display of the display unit to display the position of the second object in the first method in a case where the one or more processors have not yet acquired information indicating that the wireless device has been detected.

8. The control apparatus according to claim 1, wherein the one or more processors operate to control the display of the display unit to display the position of the first object in the first method and the position of the second object in the second method in a case where the one or more processors have not yet acquired information indicating that the wireless device has been detected.

9. The control apparatus according to claim 1, wherein the one or more processors operate to:
control the display of the display unit to display a state in which the wireless device is detected in a case where the one or more processors have acquired information indicating that the wireless device has been detected, and
control the display of the display unit to display a state in which the wireless device is not detected in a case where the one or more processors have not acquired information indicating that the wireless device.

10. The control apparatus according to claim 1, further comprising a communication unit configured to communicate with the wireless device.

11. The control apparatus according to claim 10, wherein the one or more processors operate to acquire the position information based on information on communication with the wireless device from the communication unit.

12. An image pickup apparatus comprising:
a control apparatus; and
an imaging unit including an image sensor,
wherein the control apparatus includes:
one or more memories storing instructions, and
one or more processors that, upon execution of the instructions, operate to:
acquire position information on a wireless device,
specify an object including the wireless device within an image using the position information, and
control a display of a display unit to display a position of a first object specified as including the wireless device in a first method, and to display a position of a second object not specified as including the wireless device in a second method different from the first method.

13. A control method comprising:
acquiring position information on a wireless device,
specifying an object including the wireless device within an image using the position information, and
controlling a display of a display unit to display a position of a first object specified as including the wireless device in a first method, and to display a position of a second object not specified as including the wireless device in a second method different from the first method.

14. A non-transitory computer-readable storage medium storing a program that causes a computer to execute the control method according to claim 13.
